(19) United States
(12) Patent Application Publication
(10) Pub. No.: US 2021/0103818 A1
(43) Pub. Date: Apr. 8, 2021

(54) NEURAL NETWORK COMPUTING METHOD, SYSTEM AND DEVICE THEREFOR

(71) Applicant: (INSTITUTE OF COMPUTING TECHNOLOGY, CHINESES ACADEMY OFSCIENCES), Beijing (CN)

(72) Inventors: Zidong DU, Beijing (CN); Qi GUO, Beijing (CN); Tianshi CHEN, Beijing (CN); Yunji CHEN, Beijing (CN)

(21) Appl. No.: 16/071,402

(22) PCT Filed: Aug. 9, 2016
(86) PCT No.: PCT/CN2016/094199

§ 371 Date: Jul. 19, 2018

(30) Foreign Application Priority Data
Mar. 16, 2016 (CN) 201610149920.9

(51) Int. Cl. G06N 3/08; G06N 3/04; G06F 15/78

(52) U.S. Cl. CPC G06N 3/082; G06F 15/781; G06N 3/0454

(57) ABSTRACT

The present disclosure provides a neural network computing method, system and device therefor to be applied in the technical field of computers. The computing method comprises the following steps: A. dividing a neural network into a plurality of subnetworks having consistent internal data characteristics; B. computing each of the subnetworks to obtain a first computation result for each subnetwork; and C. computing a total computation result of the neural network on the basis of the first computation result of each subnetwork. By means of the method, the present disclosure improves the computing efficiency of the neutral network.

### TECHNICAL FIELD

The present disclosure relates to the technical field of computers, and in particular, relates to a neural network computing method, system and device therefor.

### BACKGROUND ART

In the era of big data, more and more devices such as industrial robots, driverless cars and mobile devices, etc. require more and more complex processing on real-time input of the real world. These tasks mostly belong to machine learning field, wherein most operations are vector operations or matrix operations, which have a high degree of parallelism. As compared to the conventional GPU/CPU acceleration schemes, hardware ASIC accelerator is the most popular acceleration scheme at present. On one hand, it can provide a high degree of parallelism so as to achieve high performance, and on the other hand, it has high energy efficiency.

However, bandwidth becomes a bottleneck that limits performance of the accelerator, and the common solutions balance disequilibrium of the bandwidth by means of on-chip cache. These common solutions do not optimize reading and writing of the data, and cannot utilize characteristics of the data well, such that cost of the on-chip storage as well as cost of data reading and writing is too much. As for current common machine learning algorithms, on one hand, data size is huge, as for hardware, the resource is quite limited, and a huge network cannot complete computation once; on the other hand, most of the data have reusability, i.e., the same data will be used for many times, such that the data has the same characteristics.

In conclusion, the current neural network computing technology obviously has inconvenience and deficiencies in practical use, so it is necessary to make improvement.

### THE PRESENT DISCLOSURE

With respect to the above deficiencies, an object of the present disclosure is to provide a network computing method, system and device therefor, so as to improve the computing efficiency of the neutral network.

In order to achieve the object, the present disclosure provides a neural network computing method, comprising the following steps:

A. dividing a neural network into a plurality of subnetworks having consistent internal data characteristics;

B. computing each of the subnetworks to obtain a first computation result for each subnetwork; and

C. computing a total computation result of the neural network on the basis of the first computation result of each subnetwork.

According to the computing method, the step A comprises:

A1. dividing the neural network into a plurality of subnetworks having consistent internal data characteristics on the basis of output neurons of the neural network;

A2. dividing the neural network into a plurality of subnetworks having consistent internal data characteristics on the basis of input neurons of the neural network; and

A3. dividing the neural network into a plurality of subnetworks having consistent internal data characteristics on the basis of neuron weights of the neural network.

According to the computing method, the step A3 comprises:
dividing the neural network into a plurality of subnetworks having consistent internal data characteristics on the basis of distribution of the neuron weights of the neural network; or
dividing the neural network into a plurality of subnetworks having consistent internal data characteristics on the basis of positive or negative of the neuron weights of the neural network.

According to the computing method, in the step C, the first computation result of each subnetwork is spliced or weighted to compute the total computation result of the neural network.

According to any one of the computing method, data of the neural network is stored in an off-chip storage medium, and data of the subnetwork is stored in an on-chip storage medium.

In order to achieve another object of the present disclosure, the present disclosure further provides a neural network computing system, comprising:
a division module for dividing a neural network into a plurality of subnetworks having consistent internal data characteristics;
a first computation module for computing each of the subnetworks to obtain a first computation result for each subnetwork; and
a second computation module for computing a total computation result of the neural network on the basis of the first computation result of each subnetwork.

According to the computing system, the division module comprises:
a first division submodule for dividing the neural network into a plurality of subnetworks having consistent internal data characteristics on the basis of output neurons of the neural network;
a second division submodule for dividing the neural network into a plurality of subnetworks having consistent internal data characteristics on the basis of input neurons of the neural network; and
a third division submodule for dividing the neural network into a plurality of subnetworks having consistent internal data characteristics on the basis of neuron weights of the neural network.

According to the computing system, the third division submodule divides the neural network into a plurality of subnetworks having consistent internal data characteristics on the basis of distribution of the neuron weights of the neural network; or
divides the neural network into a plurality of subnetworks having consistent internal data characteristics on the basis of positive or negative of the neuron weights of the neural network.

According to the computing system, the second computation module splices or weights the first computation result of each subnetwork to compute the total computation result of the neural network;
data of the neural network is stored in an off-chip storage medium, and data of the subnetwork is stored in an on-chip storage medium.

In order to achieve another object of the present disclosure, the present disclosure further provides a device for any one of the computing system, comprising:
an on-chip storage and addressing module disposed in an on-chip storage medium, and connected to an on-chip address index module and an on-chip computation module for storing data of the subnetwork;
the address index module for indexing data stored in the on-chip storage and addressing module; and
the on-chip computation module for computing a first computation result of the subnetwork.

### BRIEF DESCRIPTION OF THE DRAWINGS

FIG. 1 is a structure diagram of a neural network computing system according to one example of the present disclosure.

FIG. 2 is a structure diagram of a neural network computing system according to one example of the present disclosure.

FIG. 3 is a schematic diagram of dividing subnetworks on the basis of output neurons according to one example of the present disclosure.

FIG. 4 is a schematic diagram of dividing subnetworks on the basis of input neurons according to one example of the present disclosure.

FIG. 5 is a schematic diagram of dividing subnetworks on the basis of a weight connection according to one example of the present disclosure.

FIG. 6A is a schematic diagram of dividing subnetworks on the basis of positive and negative of weights according to one example of the present disclosure.

FIG. 6B is a schematic diagram of dividing subnetworks on the basis of distribution of weights according to one example of the present disclosure.

FIG. 7 is a schematic diagram of dividing subnetworks on the basis of positive and negative of weights and possible optimization of mean value according to one example of the present disclosure.

FIG. 8A is a structure diagram of a neural network computing device according to one example of the present disclosure.

FIG. 8B is a block diagram of an overall structure of computation of the neural network according to one example of the present disclosure.

FIG. 9 is a flow diagram of the neural network computing method according to one example of the present disclosure.

FIG. 10 is a flow diagram of the neural network computing method according to one example of the present disclosure.

### EMBODIMENTS

In order to clarify the object, the technical solution and the advantages, the present disclosure is further explained in detail with reference to the drawings and the examples. It shall be understood that the specific examples described here are only to explain the present disclosure, instead of limiting the present disclosure.

Referring to FIG. 1, in the first example of the present disclosure, it provides a neural network computing system 100, comprising:
a division module 10 for dividing a neural network into a plurality of subnetworks having consistent internal data characteristics;
a first computation module 20 for computing each of the subnetworks to obtain a first computation result for each subnetwork; and
a second computation module 30 for computing a total computation result of the neural network on the basis of the first computation result of each subnetwork.

In this example, a neural network computing system 100 is provided, through which a neural network is divided into a plurality of subnetworks at first. According to different division principles, the neural network can be divided into different subnetworks, and different division methods result in different characteristics of the subnetworks, wherein data of the neural network is stored in off-chip storage medium, and data of the subnetwork is stored in on-chip storage medium. Specifically, the division module 10 divides the neural network into different subnetworks according to different division principles. The division principles make internal data characteristics of the same subnetwork have consistency, whereas data of different subnetworks may have different properties and different subnetworks may be stored in different mediums, such as, in (i.e., on-chip) and out of the chip, so as to be dispatched by hardware for computation at different times. The first computation module 20 performs subnetwork computation by computing each of the subnetworks to obtain a first computation result for each subnetwork. Generally, limited on-chip resources limit the possibility of computing all data simultaneously, so data is divided. Large storage medium (cheap, slow speed) is placed out of the chip, and small storage medium (expensive, fast speed) is integrated on the chip. Data is stored in the off-chip storage in accordance with subnetworks, and is carried to the computation module for related operations of subnetworks at different times. Although the neural network itself may be a complex huge network, computation of each subnetwork is consistent with that of the original network itself. Finally, the second computation module 30 computes the total computation result of the neural network by splicing or weighting the first computation result of each subnetwork. Different operations are performed on different subnetworks according to different division principles. For example, the second computation module 30 simply splices or computes to obtain the final computation result of the total network. Therefore, it improves the computing efficiency of the neutral network.

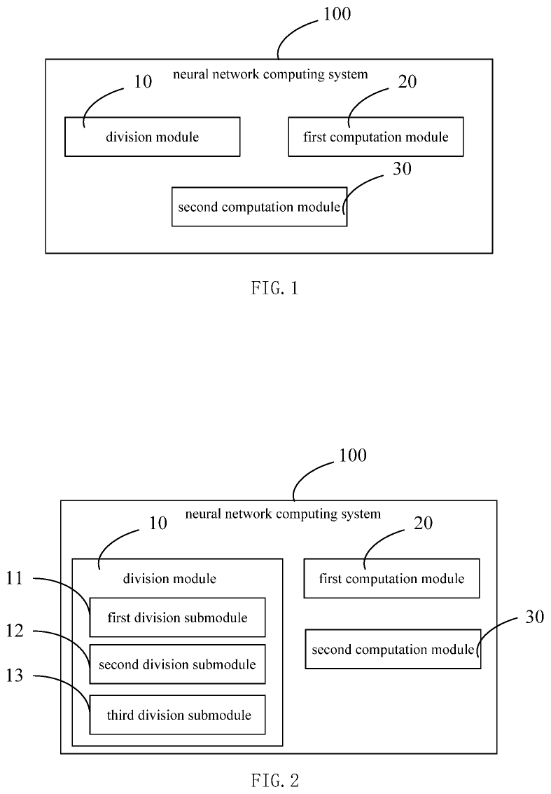

Referring to FIG. 2, in the second example of the present disclosure, the division module 10 comprises:
a first division submodule 11 for dividing the neural network into a plurality of subnetworks having consistent internal data characteristics on the basis of output neurons of the neural network;
a second division submodule 12 for dividing the neural network into a plurality of subnetworks having consistent internal data characteristics on the basis of input neurons of the neural network; and
a third division submodule 13 for dividing the neural network into a plurality of subnetworks having consistent internal data characteristics on the basis of neuron weights of the neural network.

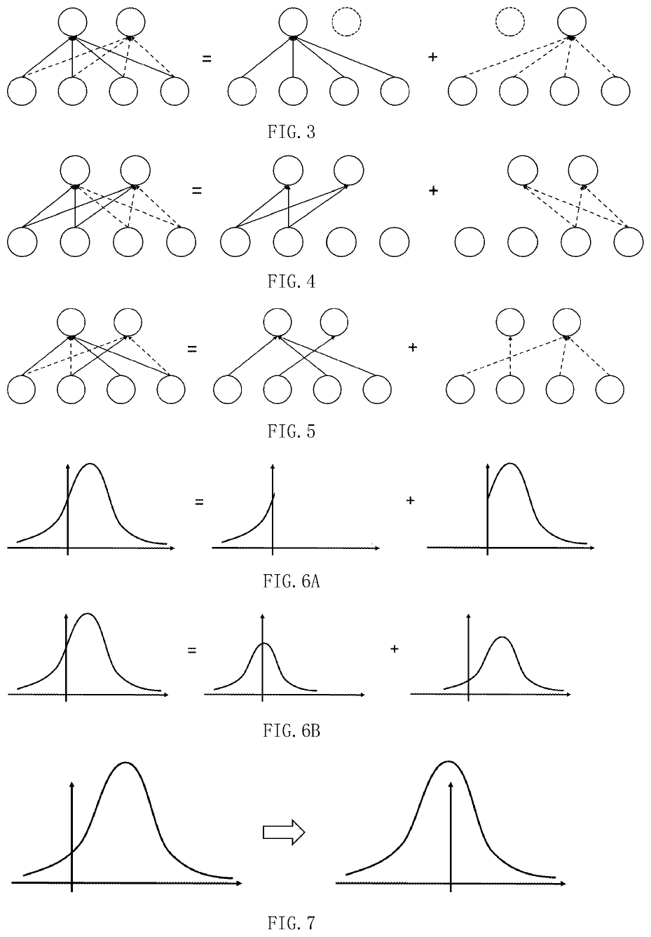

In this example, subnetwork division principles in the present disclosure comprise division according to output neurons, division according to input neurons, and division according to weights. The first division submodule 11, the second division submodule 12 and the third division submodule 13 perform division according to different division principles. As for the subnetwork division method shown in FIG. 3, the division principle is on the basis of output neurons. Different output neurons compute an output result on the basis of all input neurons, wherein there are connections with different weights between the neurons. In FIG. 3, four neurons are inputs, two neurons are outputs, and is the connection between input and output neurons is full connection. According to output neurons of the neural network, two subnetworks compute one output neuron, respectively. FIG. 4 is a neural network (with the same scale as that in FIG. 3), which is divided into subnetworks according to input neurons, and each subnetwork only comprises two input neurons. Division principles according to input and output neurons as shown in FIGS. 3 and 4 are not limited to full connection cases, and are also adapted to non-full connection conditions. FIG. 5 is an example of dividing subnetworks according to weights, wherein each subnetwork only computes one connection, and a sum of subnetworks is a total network.

In addition, the third division submodule 13 divides the neural network into a plurality of subnetworks having consistent internal data characteristics on the basis of distribution of the neuron weights of the neural network; or
divides the neural network into a plurality of subnetworks having consistent internal data characteristics on the basis of positive and negative of the neuron weights of the neural network.

As for subnetwork division shown in FIG. 5, the principle is to divide according to the weight connection of neurons. The weights have different attributes, such that the network can be divided into different subnetworks according to different division principles. Here, the network is divided into two subnetworks according to the weights. In addition, on the basis of the division principles of the weights, subnetwork division shown in FIG. 5 further comprises positive and negative (i.e., dividing the entire network into positive subnetworks and negative subnetworks), threshold values (i.e., dividing the network into subnetworks greater than x and subnetworks less than or equal to x), and sections (i.e., dividing the network into different subnetworks with weights formed in different intervals), and so on. Moreover, dividing the subnetworks on the basis of the weights further comprises complex division principles, such as, dividing on the basis of distribution of the weights. In one embodiment of the present disclosure, the subnetwork division shown in FIG. 6A is dividing the network into positive and negative subnetworks on the basis of positive and negative of the weights. Subnetwork division shown in FIG. 6B is dividing on the basis of distribution of the weights, wherein the network with weights complying with a normal distribution is divided into two subnetworks with weights complying with normal distributions. One advantage of the subnetwork division principle in the example shown in FIG. 6B is that a range of weight distribution of each subnetwork can be narrowed by division, such that the weights in each subnetwork can be represented as a mean value and a deviation. As seen from a hardware perspective, the mean value can be reused, and the deviation can be directly stored, or clustered, or compressed, thereby reducing hardware resource requirements, and reducing hardware overhead. In addition, the subnetwork division principles further comprise division according to connection, which division principle can be naturally classified to division according to input or output neurons, so the present disclosure does not particularly classify it as one type. Subnetwork computation is the same as that of the original neural network, and subnetwork division does not introduce additional operations in each subnetwork.

In one example of the present disclosure, as for subnetwork division principle in one example shown in FIG. 7, numerical values are represented after transformation on the basis of weights distribution, i.e., a single numerical value is decomposed into a form of a+b, wherein a is a mean value, and b is a deviation of the numerical value relative to the mean value (b may be either positive or negative). One advantage of the division principle in the example shown in FIG. 7 is that b is distributed symmetrically relative to the point 0, and can be represented by data with minimum bits, and a is the same for all numerical values, so that the subnetwork is divided into two networks, one is a mean value subnetwork, and the other is a deviation subnetwork. In terms of hardware resources, all weights in the mean value subnetwork are consistent, which greatly reduces times of reading the weight data of the subnetwork. For example, if there is an on-chip register, reading once is enough for unlimited times of usage. On one hand, the representation of weights in the deviation subnetwork efficiently reduces a bit width for representing each numerical value, thereby reducing the bandwidth requirements, and on the other hand, deviation weights can be clustered or compressed, such that the bandwidth does not become a bottleneck in computation.

In the examples aforesaid, a plurality of modules of the neural network computing system 100 can be software units, hardware units, or software and hardware combined units.

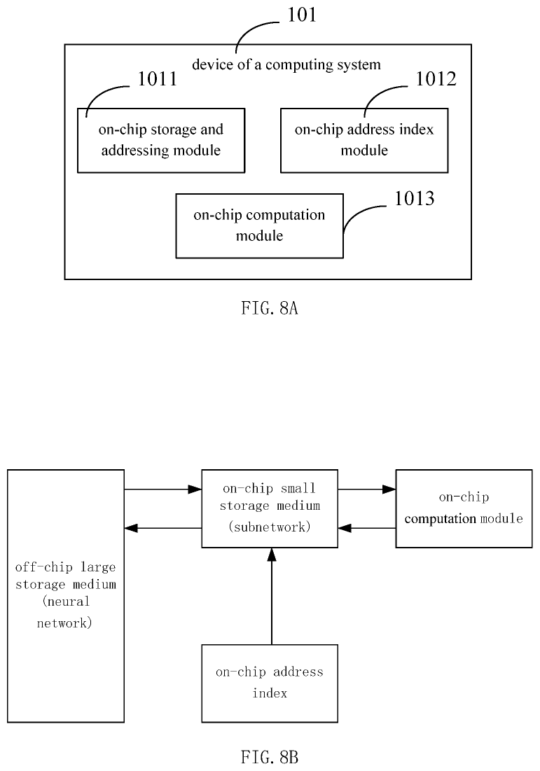

Referring to FIGS. 8A and 8B, in the third example of the present disclosure, a device 101 for the plurality of computing systems is further provided, which device comprises:
an on-chip storage and addressing module 1011 disposed in an on-chip storage medium, and connected to an on-chip address index module 1012 and an on-chip computation module 1013 for storing data of the subnetwork;
the address index module 1012 for indexing data stored in the on-chip storage and addressing module 1011; and
the on-chip computation module 1013 for computing a first computation result of the subnetwork.

In this example, the device 101 of the neural network computing system comprises the on-chip storage and addressing module 1011, the on-chip address index module 1012 and the on-chip computation module 1013. The on-chip address index module 1012 indexes data stored on the chip; a data read-out interface of the on-chip storage and addressing module 1011 is an output port of the indexed data; a data write-in interface of the on-chip storage and addressing module 1011 is an interface through which data of the storage unit is written into a corresponding storage position according to a write address. The on-chip storage and addressing module 1011 adopts a design with read port and write port separated, such that reading and writing of the data are independent from each other and may be performed simultaneously. Therefore, repetitive addressing in an on-chip address space can be performed efficiently, and addressing of off-chip addresses can be performed also. Specifically, there are an on-chip storage medium, an off-chip storage medium, an address index unit, channel between on-chip and off-chip data, and on-chip data channels. The on-chip storage medium comprises common storage mediums, such as, a Static Random Access Memory (SRAM), a Dynamic Random Access Memory (DRAM), an Enhanced Dynamic Random Access Memory (eDRAM), a Register file (RF) and the like, and also can be novel storage devices, such as, a Non-Volatile Memory (NVM), or a 3D storage device and the like. As for the on-chip storage medium, it is not limited to storage mediums. The off-chip storage medium comprises common storage mediums, such as, a Static Random Access Memory (SRAM), a Dynamic Random Access Memory (DRAM), an Enhanced Dynamic Random Access Memory (eDRAM), a Register file (RF) and the like, and also can be novel storage devices, such as, a Non-Volatile Memory (NVM), or a 3D storage device and the like. Address space is divided into off-chip data space and on-chip data space. Address space division has a strong flexibility, and is not limited to a size of the address space. The channels between on-chip and off-chip data comprise interconnection techniques of PCI, PCIE, HT and the like, and the channels between on-chip and off-chip data are not limited to interconnection techniques. The on-chip data channels comprise interconnection techniques of FATTREE, HTREE and the like, and the on-chip data channels are not limited to interconnection techniques. Data of the neural network and the subnetworks can be read and written once or many times, and data can be read to one or more on-chip computation units. The on-chip storage medium can be read and written once or many times from outside, and the on-chip storage medium can be read and written once or many times from inside. The off-chip storage medium can be read and written once or many times, and data of the off-chip storage medium can be read to one or more on-chip computation units. The off-chip storage medium can be read and written once or many times from outside, and the off-chip storage medium can be read and written once or many times from inside. The on-chip storage medium comprises one or more replacement. A data replacement strategy of the on-chip storage medium comprises sequential replacement, reversed replacement, random replacement and the like.

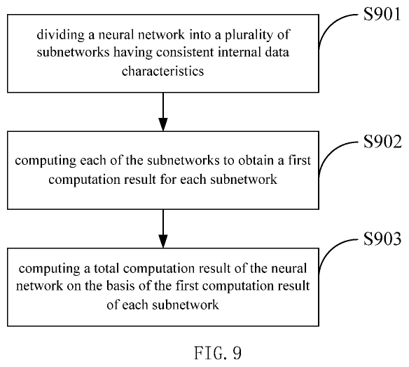

Referring to FIG. 9, in the fourth example of the present disclosure, a neural network computing method is provided, which comprises the following steps:
in step S901, dividing, by the division module 10, a neural network into a plurality of subnetworks having consistent internal data characteristics;
in step S902, computing, by the first computation module 20, each of the subnetworks to obtain a first computation result for each subnetwork; and
in step S903, computing, by the second computation module 30, a total computation result of the neural network on the basis of the first computation result of each subnetwork.

In this example, the neural network is divided by the division module 10 into subnetworks, such that by means of accelerating individual subnetwork, computation of the subnetworks can be rapidly and efficiently completed by a chip, and computation of the total network is rapidly and efficiently. According to different division principles, the neural network is divided into different subnetworks organized by the first computation module 20 and the second computation module 30 for computation. In addition, data of the neural network is stored in an off-chip storage medium, and data of the subnetwork is stored in an on-chip storage medium. The first computation result of each subnetwork is spliced or weighted to compute the total computation result of the neural network. The present disclosure can effectively provide reusability of the data, fulfill the requirements of flexible addressing, efficiently satisfy the requirements for hardware resources, such as, the bandwidth, and can be adapted to different scenes.

In another example of the present disclosure, the step S901 comprises:
dividing, by the first division submodule 11, the neural network into a plurality of subnetworks having consistent internal data characteristics on the basis of output neurons of the neural network;
dividing, by the second division submodule 12, the neural network into a plurality of subnetworks having consistent internal data characteristics on the basis of input neurons of the neural network; and
dividing, by the third division submodule 13, the neural network into a plurality of subnetworks having consistent internal data characteristics on the basis of neuron weights of the neural network.

The third division submodule 13 divides the neural network into a plurality of subnetworks having consistent internal data characteristics on the basis of distribution of the neuron weights of the neural network; or
divides the neural network into a plurality of subnetworks having consistent internal data characteristics on the basis of positive and negative of the neuron weights of the neural network.

As for a heterogeneous platform, the data can be stored on the chip of an accelerator is quite limited. Currently, the neural network often has a large scale, thus it is required to divide the entire neural network into different subnetworks for computation, and the required data block is read in or written out through interaction of data on the off-chip large storage medium and the on-chip small storage medium. Finally, a total network result is computed on the basis of the computation results of different subnetworks. On-chip and off-chip data connection shown in FIG. 8B is not limited to PCIE bus connection, and may also include a multi-chip interconnection structure, such as, an on-chip network. A data channel between the on-chip computation unit and the on-chip storage medium shown in FIG. 8B is not limited to interconnection techniques of H-TREE, or FAT-TREE.

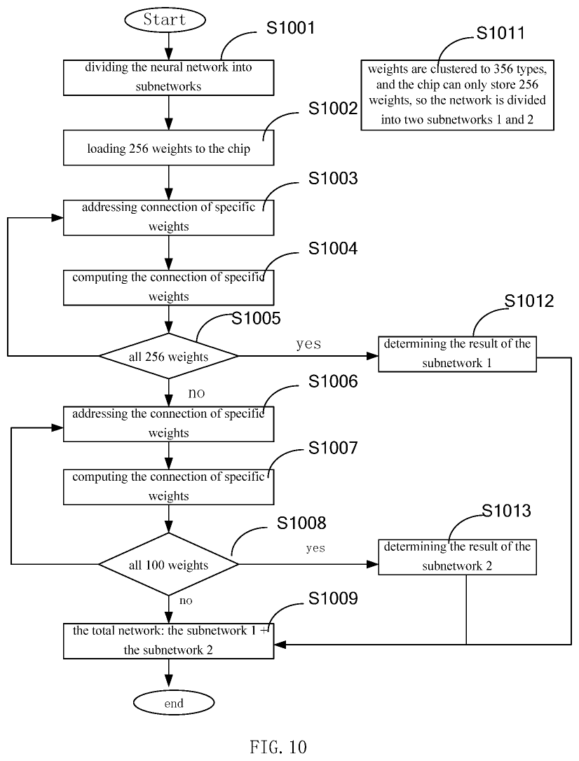

In one example of the present disclosure, the computing flow of the neural network shown in FIG. 10 takes one layer of neural network which clusters weights for example, i.e., FIG. 6A, and is specifically described as follows:
in step S1001, dividing the neural network into subnetworks, and as for the network division method in this example, please see step S1011. In step S1011, hypothesizing that weights are clustered to three hundred and fifty-six (356) types, while the on-chip resource can only store two hundred and fifty-six (256) weights, so according to storage limit, the network is divided into two subnetworks, i.e., subnetworks 1 and 2;
in step S1002, loading 256 weights to the chip, and making preparation of data for computation of the subnetwork 1;
in step S1003, addressing connection of specific weights;
in step S1004, computing the connection of specific weights;
in step S1005, judging whether computation of the subnetwork 1 has been completed, i.e., all 256 weights have been used, if yes, entering S1012 to determine a computation result of the subnetwork 1, and S1006 to compute the subnetwork 2; if not, entering step S1003 to continue computation of the subnetwork 1;
in step S1006, addressing the connection of specific weights;
in step S1007, computing the connection of specific weights;
in step S1008, judging whether computation of the subnetwork 2 has been completed, i.e., all 100 weights have been used, if yes, entering S1013 to determine a computation result of the subnetwork 2, and S1009 to compute the total network; if not, entering step S1006 to continue computation of the subnetwork 2;
in step S1009, computing the total network, i.e., the subnetwork 1 and the subnetwork 2;
in step S1012, determining the result of the subnetwork 1; in step S1013, determining the result of the subnetwork 2.

In this example, the neural network is divided into subnetworks, and weights of the neural network are clustered to 356 types, i.e., 356 weights. Hypothesizing that a weight cache on the chip can only store 256 values, naturally the neural network is divided into two types, one type is a network connected using the former 256 weights, i.e., the subnetwork 1, and the other type is a network connected using the remaining 100 weights, i.e., the subnetwork 2. Hence, as for the final neuron result, it is only required to add accumulation results of the subnetworks 1 and 2 so as to obtain the final result of the total network. After beginning to compute, the former 256 weights are loaded to the chip, all output neurons are addressed one by one according to input neurons and then computed till all weights are used, and computation of the subnetwork 1 is completed. Similarly, computation of the subnetwork 2 is completed. Results of the subnetworks 1 and 2 are added to obtain the final result of the total network. It shall be noticed that the storage devices in various examples of the present disclosure are not limited to storage-specific mediums, may be common storage mediums, such as, a Static Random Access Memory (SRAM), a Dynamic Random Access Memory (DRAM), an Enhanced Dynamic Random Access Memory (eDRAM), a Register file (RF) and the like, and can be novel storage devices also, such as, a Non-Volatile Memory (NVM), or a 3D storage device and the like.

In conclusion, by means of dividing a neural network into a plurality of subnetworks having consistent internal data characteristics; computing each of the subnetworks to obtain a first computation result for each subnetwork; and computing a total computation result of the neural network on the basis of the first computation result of each subnetwork, the present disclosure can cut on-chip cache overhead by reasonably dispatching data, so as to provide a design of more efficient accelerator. Due to effective division of the large scale data, the requirements for hardware resources, such as, the requirements for access bandwidth, are reduced while a good flexibility is provided, and the problem of efficiently reading and writing repetitive data is solved.

Certainly, the present disclosure also may have other multiple examples, and without departing from the spirit and substance of the present disclosure, those skilled in the art shall make various corresponding modifications and variations according to the present disclosure, but these corresponding modifications and variations shall belong to the scope protected by the appended claims.

### INDUSTRIAL APPLICABILITY

By means of dividing a neural network into a plurality of subnetworks having consistent internal data characteristics; computing each of the subnetworks to obtain a first computation result for each subnetwork; and computing a total computation result of the neural network on the basis of the first computation result of each subnetwork, the present disclosure can cut on-chip cache overhead by reasonably dispatching data, so as to provide a design of more efficient accelerator. Due to effective division of the large scale data, the requirements for hardware resources, such as, the requirements for access bandwidth, are reduced while a good flexibility is provided, the problem of efficiently reading and writing repetitive data is solved, and the computing efficiency of the neural network is improved.

1. A neural network computing method, comprising the following steps:
A. dividing a neural network into a plurality of subnetworks having consistent internal data characteristics;
B. computing each of the subnetworks to obtain a first computation result for each subnetwork; and
C. computing a total computation result of the neural network on the basis of the first computation result of each subnetwork.

2. The computing method according to claim 1, wherein the step A comprises:
A1. dividing the neural network into a plurality of subnetworks having consistent internal data characteristics on the basis of output neurons of the neural network;
A2. dividing the neural network into a plurality of subnetworks having consistent internal data characteristics on the basis of input neurons of the neural network; and
A3. dividing the neural network into a plurality of subnetworks having consistent internal data characteristics on the basis of neuron weights of the neural network.

3. The computing method according to claim 2, wherein the step A3 comprises:
dividing the neural network into a plurality of subnetworks having consistent internal data characteristics on the basis of distribution of the neuron weights of the neural network; or
dividing the neural network into a plurality of subnetworks having consistent internal data characteristics on the basis of positive or negative of the neuron weights of the neural network.

4. The computing method according to claim 1, wherein in the step C, the first computation result of each subnetwork is spliced or weighted to compute the total computation result of the neural network.

5. The computing method according to claim 1, wherein data of the neural network is stored in an off-chip storage medium, and data of the subnetwork is stored in an on-chip storage medium.

6. The computing method according to claim 2, wherein data of the neural network is stored in an off-chip storage medium, and data of the subnetwork is stored in an on-chip storage medium.

7. The computing method according to claim 3, wherein data of the neural network is stored in an off-chip storage medium, and data of the subnetwork is stored in an on-chip storage medium.

8. The computing method according to claim 4, wherein data of the neural network is stored in an off-chip storage medium, and data of the subnetwork is stored in an on-chip storage medium.

9. A neural network, comprising:
a division module for dividing a neural network into a plurality of subnetworks having consistent internal data characteristics;
a first computation module for computing each of the subnetworks to obtain a first computation result for each subnetwork; and
a second computation module for computing a total computation result of the neural network on the basis of the first computation result of each subnetwork.

10. The computing system according to claim 9, wherein the division module comprises:
a first division submodule for dividing the neural network into a plurality of subnetworks having consistent internal data characteristics on the basis of output neurons of the neural network;
a second division submodule for dividing the neural network into a plurality of subnetworks having consistent internal data characteristics on the basis of input neurons of the neural network; and
a third division submodule for dividing the neural network into a plurality of subnetworks having consistent internal data characteristics on the basis of neuron weights of the neural network.

11. The computing system according to claim 10, wherein the third division submodule divides the neural network into a plurality of subnetworks having consistent internal data characteristics on the basis of distribution of the neuron weights of the neural network; or
divides the neural network into a plurality of subnetworks having consistent internal data characteristics on the basis of positive or negative of the neuron weights of the neural network.

12. The computing system according to claim 9, wherein the second computation module splices or weights the first computation result of each subnetwork to compute the total computation result of the neural network;
data of the neural network is stored in an off-chip storage medium, and data of the subnetwork is stored in an on-chip storage medium.

13. A device for the neural network computing system wherein,
the neural network computing system, comprising:
a division module for dividing a neural network into a plurality of subnetworks having consistent internal data characteristics;
a first computation module for computing each of the subnetworks to obtain a first computation result for each subnetwork; and
a second computation module for computing a total computation result of the neural network on the basis of the first computation result of each subnetwork;
the device comprising:
an on-chip storage and addressing module arranged in an on-chip storage medium, and connected to an on-chip address index module and an on-chip computation module for storing data of the subnetwork;
the address index module for indexing data stored in the on-chip storage and addressing module; and
the on-chip computation module for computing the first computation result of the subnetwork.

14. The device for the neural network computing system according to claim 13, wherein the division module comprises:
a first division submodule for dividing the neural network into a plurality of subnetworks having consistent internal data characteristics on the basis of output neurons of the neural network;
a second division submodule for dividing the neural network into a plurality of subnetworks having consistent internal data characteristics on the basis of input neurons of the neural network; and
a third division submodule for dividing the neural network into a plurality of subnetworks having consistent internal data characteristics on the basis of neuron weights of the neural network.

15. The device for the neural network computing system to claim 14, wherein the third division submodule divides the neural network into a plurality of subnetworks having consistent internal data characteristics on the basis of distribution of the neuron weights of the neural network; or
divides the neural network into a plurality of subnetworks having consistent internal data characteristics on the basis of positive or negative of the neuron weights of the neural network.

16. The device for the neural network computing system to claim 13, wherein the second computation module splices or weights the first computation result of each subnetwork to compute the total computation result of the neural network;
data of the neural network is stored in an off-chip storage medium, and data of the subnetwork is stored in an on-chip storage medium.
